(19) United States
(12) Patent Application Publication
(10) Pub. No.: US 2024/0209660 A1
(43) Pub. Date: Jun. 27, 2024

(54) DOOR SYSTEM WITH MONITORING OVER TIME OF THE LOCKING DEVICES

(71) Applicant: Bode - Die Tür GmbH, Kassel (DE)

(72) Inventors: Benjamin Scheffer, Calden (DE); Markus Rosenthal, Bamberg (DE); Christian Gitter, Zeil (DE); Jörg Stübinger, Mainleus (DE)

(21) Appl. No.: 18/537,320

(22) Filed: Dec. 12, 2023

(30) Foreign Application Priority Data
Dec. 21, 2022 (DE) 10 2022 134 325.1

(51) Int. Cl. E05B 81/66

(52) U.S. Cl. CPC E05B 81/66

(57) ABSTRACT

A door system for a vehicle with a door opening, with at least one door leaf that closes in a closed condition the door opening, wherein the door leaf includes at least one locking device for locking the door leaf in the closed condition. The door system includes a monitoring unit configured for monitoring over time and evaluate an actuation process of the at least one locking device.

### CROSS-REFERENCE TO RELATED APPLICATIONS

This application claims the benefit of German patent application 10 2022 134 325.1, filed on 21 Dec. 2022, the disclosure of which is incorporated herein by reference in its entirety.

### TECHNICAL FIELD

The disclosure relates to a door system for a vehicle with a door opening, and with at least one door leaf that closes in a closed condition the door opening, wherein the door leaf comprises at least one locking device for locking the door leaf in the closed condition. For monitoring over time the locking process of the locking devices of the door leaf, the door system comprises a monitoring unit.

### BACKGROUND

Door systems are frequently used in public transport vehicles and low-floor vehicles, such as buses and trains.

For this purpose, the door systems conventionally have a portal frame, which is firmly connected to the vehicle, and in which at least one door leaf, frequently two door leaves, are guided. The door system is often inserted into a door opening in an outer shell of the vehicle, using the portal frame as a separate sub-assembly.

For opening and closing the door opening, the door leaf is moved by a drive unit and guided by guiding members. The drive unit includes, for example, a rotary post moved by a hydraulic, electric or pneumatic actuator.

In the closed condition of the door leaf, the door leaf is secured with at least one locking device. As a rule, the door leaf has two locking devices, of which one is arranged at the top of the door leaf and one at the bottom of the door leaf. The door leaf is connected to the portal frame by a positive fit of the locking devices. This may take place, for instance, by a locking bar, which moves from the portal frame into an opening in the door leaf, or from the door leaf into an opening in the portal frame.

In operation, such pivot sliding doors run through many hundred thousand or even more than one million opening and closing cycles. Due to wear on the locking devices, settling phenomena or the distortion of individual components of the door system, disturbances in the operation of the door system may occur, so that the door leaves can no longer be locked in the closed position or the force and thus the energy for bringing the door leaves into the closed position is increased. This may make the function of the door system more difficult or even prevent it, which may result in a failure of the entire vehicle.

In order to prevent this or even recognize it early on, systems are known that are able to determine an increased energy requirement of the drive unit and therefor draw a conclusion regarding a wear or damage to the door system. However, the wear or the damage has at this point in time already progressed far, and the drive unit has already been exposed to a higher load over a longer period of time.

### SUMMARY

Therefore, the disclosure provides a door system which provides an improved recognition of wear and/or damages.

The is achieved by providing a door system having the features of claim 1. Other particularly advantageous embodiments of the disclosure are disclosed by the respective dependent claims.

It must be noted here that the features cited individually in the claims can be combined with each other in any technologically meaningful manner (also across the boundaries of categories, such as method and device) and represent other embodiments of the disclosure. The description, in particular in connection with the Figures, characterizes and specifies the disclosure.

The disclosure is a door system for a vehicle, in particular a rail vehicle, with a door opening, with at least one door leaf that closes in a closed condition the door opening, wherein the door leaf comprises at least one locking device for locking the door leaf in the closed condition. The disclosure is characterized in that the door system comprises a monitoring unit configured for monitoring over time and evaluate an actuation process of the at least one locking device.

The door leaves are configured to close a door opening of a vehicle in a closed condition (closing condition) and make it free in an opened condition (opening condition). The door opening is incorporated into a wall of the vehicle. The wall is formed by an outer side of the vehicle and an inner side of the vehicle spaced apart from the outer side, so that the wall has a certain wall thickness due to the distance of the outer side from the inner side. The outer side may also be referred to as an outer shell. The door opening is incorporated as a cut-out into a wall of the vehicle and extends from the outer shell to the inner side. The door opening has a width (in the driving direction of the vehicle) extending in the horizontal direction and a height extending in the vertical direction. Due to the wall thickness, the door opening therefore also has a depth extending in the horizontal direction from the outer shell to the inner side, which, however, is much smaller than the width and the height, and is dependent on the wall thickness of the vehicle.

In the door opening, a portal frame is preferably inserted in which the door leaf is movably guided and can be moved by a drive unit.

The door leaf comprises at least one locking device, preferably two locking devices, more preferably a locking device at a top end of the door leaf and a locking device at a lower end of the door leaf. The locking device serves for locking the door leaf in the closed condition. Thus, the door leaf obtains an additional fixing which stabilizes the door leaf and prevents an unwanted movement of the door leaf into the opened condition.

The locking device comprises at least two components engaging each other, e.g. a movably supported locking bar and an opening corresponding thereto, into which the locking bar can engage. Therefore, the locking device is in part arranged on the door leaf and in part arranged on the vehicle or, for instance, in a portal frame. If in this case, the movably supported part with the locking bar is arranged on the door leaf and the opening in the vehicle, or vice versa, plays no role. In any case, the locking device is a locking device of the door leaf in the sense of the application.

For monitoring the locking device, the door system comprises a monitoring unit configured for monitoring over time and evaluate at least one actuation process of the at least one locking device. The disclosure is based on the idea that a wear on the door system becomes relatively early noticeable on the locking devices of the door leaves. The door leaves, when the vehicle is delivered, are very exactly adapted to the door opening and adjusted, so that the locking devices extend or snap in without resistance and at defined points in time in the locking process.

Due to the use of the door system, wear and damages may occur, such as distortion to the components in the guidance of the door leaf or in the drive unit, so that the locking devices extend or snap in later or at different points in time, or only extend partially. If it is stated in the application that the locking device retracts or extends, this may also mean that a part of the locking device, e.g. a locking bar or a cylinder, retracts or extends.

If the locking device do not extend at all, or if the door leaves no longer arrive completely in the closed condition, this can be detected by the use of final position sensors. However, the door system is then no longer usable so that a failure can no longer be prevented. It is also conceivable that the locking device itself works as a final position sensor. For example by detecting that the locking device is not completely retracted or extended.

By means of the monitoring unit, the actuation process of the locking device is therefore monitored over time and the data determined are evaluated. An actuation process may be an opening and/or closing process of the locking device. Thus, if a locking device closes or opens later or earlier than expected, an early conclusion as to a wear or a deficiency of the door system which may soon arise can be made by means of the monitoring unit. For this purpose, the actuation processes and actuation times of different locking devices on one door leaf or different door leaves may also be compared to one another. If, for instance, the top locking device of a door leaf snaps in earlier or later than the lower locking device, a distortion of the door leaf or an incorrect alignment of the door leaf could be present.

The monitoring unit may be a part of an already present control, such as of the door system or of the vehicle, for instance, or be formed by an independent module.

Advantageous embodiments and variants of the disclosure become apparent from the dependent claims and the following description. The features cited individually in the dependent claims may be combined in any technologically meaningful manner both with each other and with the features presented in more detail in the following description, and can represent other advantageous embodiment variants of the disclosure.

In a preferred embodiment of the door system, the at least one locking device comprises an extendable locking bar. In this case, the monitoring unit monitors in time an extension and/or retraction of the locking bar and evaluates the data obtained from the monitoring.

The locking device comprises two essential components. On the one hand a mechanism with an extendable locking bar, and an opening into which the locking bar engages in the extended state. The locking bar can execute a translational movement and/or a rotational movement and/or a pivoting movement when extending or retracting.

By means of the monitoring unit, the time, for instance, can be acquired which the locking bar requires for retracting and/or extending, however, the absolute points in time of reaching an extended position (locked position) and/or a retracted position (opened position) of the locking bar in the locking device can also be acquired by the monitoring unit. Therefore, in another preferred embodiment of the door system, the monitoring unit detects the point in time of the locking bar reaching a completely retracted position and/or a completely extended position. In this case, the completely extended position is the position of the locking bar in which the locking bar is maximally extended in the closed condition of the door leaf. In this case, the completely retracted position is the position of the locking bar in which the locking bar is maximally retracted.

In another preferred embodiment of the door system, the monitoring unit detects the time of the extending and/or retracting of the locking bar. Thus, the time is meant that the locking bar needs to arrive from the retracted position in the extended position or vice versa. It is also conceivable that the time is acquired at which the locking bar reaches certain positions.

In another preferred embodiment of the door system, the monitoring unit is configured for taking into account in the evaluation a target value in time and/or a threshold value in time. The above-mentioned times or points in time are compared to a target value and/or threshold value. However, ranges for the target value with upper and lower limits may be provided. During the comparison, the deviations of the target value or the threshold value are determined, so that a conclusion as to a wear or imminent defect can be made in the case of deviations that are too big or if the set threshold values are exceeded or dropped below. The target values or threshold values may in this case be selected such that a wear or an imminent defect is recognized early but an operation of the door system is still possible without any problems.

The target values or threshold values may include several stages, so that different warning levels can be outputted. For instance, Stage 1 if the threshold value 1 is exceeded: low wear, no action required—Stage 2 if the threshold value 2 is exceeded: medium wear, maintenance in the case of the next routine inspection of the vehicle—Stage 3 if the threshold value 3 is exceeded: high wear, maintenance as quickly as possible—Stage 4 if the threshold value 4 is exceeded: defect present, continued use is not possible.

In another preferred embodiment of the door system, the monitoring unit is configured for outputting an error notification when the target value in time and/or the threshold value in time are exceeded or dropped below. In order for the operator of the vehicle or of the door system to be informed of the state of the door system, it may be provided that the monitoring unit outputs an error notification if a wear or a defect was found in the evaluation. This may take place, for instance, optically via a lamp or a display on the door system or on the vehicle. It is also possible to output an acoustic warning.

In another preferred embodiment of the door system, the at least one door leaf includes at least two locking devices. The monitoring unit compares in time the actuation process of the first locking device with an actuation process of the second locking device. As a rule, the door leaves of door systems have several locking devices, e.g. a locking device at a top end of the door leaf and one at a lower end of the door leaf. Therefore, it is an offer to compare the actuation processes of the two locking devices with one another in order to be able to draw conclusions as to a wear or an imminent defect. For example, the lower locking device comes into contact with a significantly greater amount of contaminations and is thus able to lock more rapidly than the upper locking device. The deviation in time of the actuation processes of the two locking devices resulting therefrom can thus be detected by the monitoring unit. A distortion of the door leaf or of the actuating mechanism of the door leaf can thus be found, because the actuation processes of the locking devices then no longer run synchronously. A deviation of the actuation processes from a normal unimpeded actuation process may thus be indicated.

In another preferred embodiment of the door system, the door system comprises at least two door leaves. The monitoring unit is configured to compare in time an actuation process of a locking device of the first door leaf with an actuation process of a locking device of the second door leaf. Deviations in time between the actuation processes of locking devices on different door leaves make it possible to draw early conclusions as to a wear or imminent defects.

In another preferred embodiment of the door system, the two door leaves are configured substantially mirror-symmetrically to each other, and arranged mirror-symmetrically in the door system to each other. The door systems are frequently mirror-symmetrically built up to the left and the right of a plane that mostly extends through the primary closing edge and perpendicularly to the driving direction of the vehicle. That means that the left door leaf is built up and arranged mirror-symmetrically to the right door leaf. Due to the mirror symmetry, the locking devices of the left door leaf are arranged at the same location as the locking devices on the right door leaf, so that the actuation processes of the locking devices behave equally during the normal operation. Thus, the actuation processes of two locking devices arranged mirror-symmetrically relative to one another can be compared in time by the monitoring unit. If deviations in time are found in the process, a conclusion can again be made as to a wear or a defect becoming apparent.

The vertically extending edge which is at the front in the closing direction of the door is referred to as the primary closing edge of a door. When two door leaves are used, these are therefore the edges which abut against each other in the closed condition of the door leaves; in the case of only one door leaf, the primary closing edge accordingly abuts against the vertically extending door opening edge in the closed position of the door.

In another preferred embodiment of the door system, each door leaf has a first locking device and a second locking device arranged opposite the first locking device, e.g. a first locking device arranged at the top end of the door leaf and, arranged opposite thereto, a second locking device at the lower end of the door leaf. The monitoring unit can compare in time the actuation process of the first (upper) locking device of the one door leaf with the actuation process of the second (lower) locking device of the second door leaf. In this way, the actuation processes of the locking devices can be compared, which are arranged crosswise in the door system.

In another preferred embodiment of the door system, for monitoring and evaluating the actuation processes of different locking devices amongst each other, the monitoring unit is configured for monitoring and evaluating the deviation in time between a respective reaching of a locked position and/or an opened position of the locking devices. The locked position is the position in which, for instance, a locking bar of the locking device is in a completely extended position, whereas the locking bar is completely retracted in the opened position.

In another preferred embodiment of the door system, the monitoring unit is configured for outputting an error notification when a maximum deviation in time between the actuation processes to be compared is exceeded.

In another preferred embodiment of the door system, the monitoring unit includes an optical and/or acoustic display for presenting a monitoring state. This may be, for instance, different warning tones, individual or multi-colored lamps, or displays for presenting more complex information.

In another preferred embodiment of the door system, the monitoring unit includes an interface for transmitting a monitoring state. Such an interface may be realized, for instance, wirelessly, as a USB port, or as a permanent cable connection to another control device of, for instance, the vehicle or a display of the vehicle. In this way, the state of the door system can be read out via a laptop or tablet, or may be displayed directly in the vehicle.

### BRIEF DESCRIPTION OF THE DRAWINGS

The present disclosure is explained in detail below based on exemplary embodiments with reference to the attached Figures. In the Figures:

FIG. 1 is a door system with two door leaves configured and arranged in a mirror-symmetrical manner,

FIG. 2 is a locking device from FIG. 1 with a locking bar in the closed position, and

FIG. 3 is a locking device with the locking bar from FIG. 2 in the opened position.

### DETAILED DESCRIPTION OF THE DRAWINGS

Unless otherwise stated, identical reference numerals in the Figures denote identical components, or components corresponding to one another with the same function.

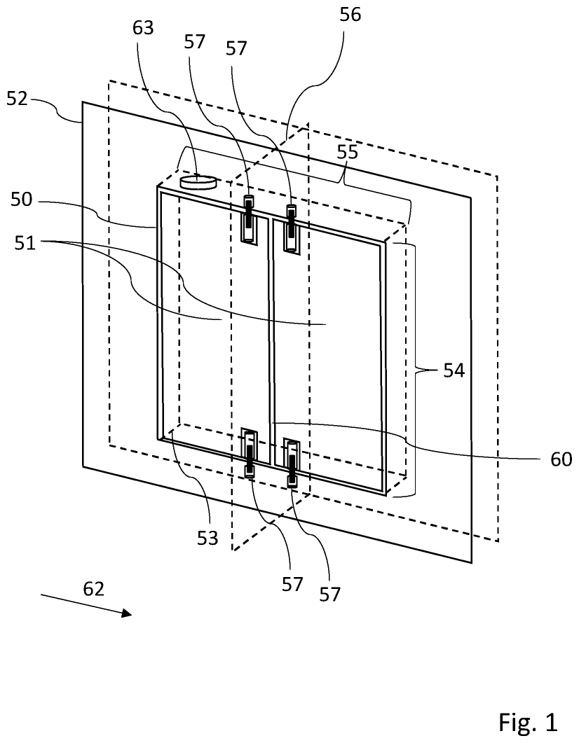

FIG. 1 shows a door opening 50 in a vehicle closed by a door system with two door leaves 51 configured and arranged in a mirror-symmetrical manner. The door opening 50 is incorporated as a substantially rectangular cut-out in the outer shell 52 of the vehicle. Starting from the outer shell 52, the vehicle has a wall with a thickness 53, wherein the thickness 53 is negligibly small in relation to a vertical height 54 and a horizontal width 55 of the door opening 50. The wall of the vehicle separates an interior space of the vehicle from the surroundings.

The two door leaves 51 are configured mirror-symmetrically and arranged mirror-symmetrically to a mirror-symmetry plane 56 to each other. The primary closing edge 60 is located between the two door leaves 51. The mirror-symmetry plane 56 extends through the primary closing edge 60 and is oriented perpendicularly to a driving direction 62 of the vehicle, wherein the driving direction 62 of the vehicle is directed in the direction of the horizontal width 55 of the door opening 50.

Each of the two door leaves 51 comprises two locking devices 57. One locking device 57 is in each case arranged at a top end of the door leaf, while the other locking device 57 is arranged at a lower end of the door leaf 51. Each locking device 57 comprises a movably supported locking bar 58, which is arranged on the door leaf 51. In the vehicle or in the portal frame, there is in each case an opening 59 of the locking device 57, into which the locking bar 58 can extend. The opening 59 and the locking device 57 or locking bar 58 may also be exchanged.

For monitoring over time the locking devices 57, the door system comprises a monitoring unit 63, which monitors over time and evaluates the actuation processes of the locking devices 57.

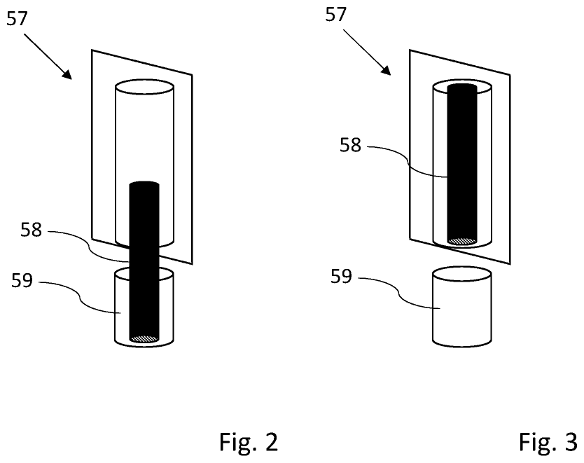

The FIGS. 2 and 3 show the actuation process of a locking device 57. FIG. 2 shows one of the locking devices 57 from FIG. 1 with the locking bar 58 in a completely extended position (locked position), whereas FIG. 3 shows the locking device 57 from FIG. 2 with the locking bar 58 in a completely retracted position (opened position). The monitoring unit 63 can in this case detect the points in time of the locking bar 58 reaching the locked position and in the opened position and determine the time span therebetween. The determined data of the different locking devices 57 are compared by the monitoring unit 63, and a conclusions as to a possible wear or an imminent damage are thus drawn.

1. A door system for a vehicle with a door opening, with at least one door leaf that closes in a closed condition the door opening, wherein the door leaf comprises at least one locking device for locking the door leaf in the closed condition,
wherein
the door system comprises a monitoring unit configured for monitoring over time and evaluate an actuation process of the at least one locking device.

2. The door system according to claim 1,
wherein
the at least one locking device includes an extendable locking bar, and the monitoring unit monitors over time and evaluates an extending and/or retracting the locking bar.

3. The door system according to claim 2,
wherein
the monitoring unit detects a point in time of the locking bar reaching a retracted position and/or an extended position.

4. The door system according to claim 2,
wherein
the monitoring unit detects the time of extending and/or retracting.

5. The door system according to claim 1,
wherein
the monitoring unit is configured for taking into account in the evaluation a target value in time and/or a threshold value in time.

6. The door system according to claim 1,
wherein
the monitoring unit is configured for outputting an error notification when the target value in time and/or the threshold value in time are exceeded or dropped below.

7. The door system according to claim 1,
wherein
the at least one door leaf comprises at least two locking devices, and the monitoring unit compares in time the actuation process of the first locking device with the actuation process of the second locking device.

8. The door system according to claim 1,
wherein
the door system comprises at least two door leaves, and the monitoring unit is configured to compare in time an actuation process of a locking device of the first door leaf with an actuation process of a locking device of the second door leaf.

9. The door system according to claim 8,
wherein
the two door leaves are configured substantially mirror-symmetrically to each other and in the door system, and the actuation processes of two locking devices arranged mirror-symmetrically to each other are compared in time.

10. The door system according to claim 8,
wherein
the two door leaves are configured substantially mirror-symmetrically to each other and arranged in the door system, wherein each door leaf has a first locking device and a second locking device arranged opposite the first locking device, and the actuation process of the first locking device of the one door leaf is compared in time with the actuation process of the second locking device of the second door leaf.

11. The door system according to claim 6,
wherein
the monitoring unit is configured for monitoring and evaluating the deviation in time between a respective reaching of a locked position and/or an opened position of the locking devices.

12. The door system according to claim 6,
wherein
the monitoring unit is configured for outputting an error notification when a maximum deviation in time between the actuation processes to be compared is exceeded.

13. The door system according to claim 1,
wherein
the monitoring unit includes an optical and/or acoustic display for presenting a monitoring state.

14. The door system according to claim 1,
wherein
the monitoring unit includes an interface for transmitting a monitoring state.
